(19) United States
(12) Patent Application Publication
(10) Pub. No.: US 2002/0148451 A1
(43) Pub. Date: Oct. 17, 2002

(54) Gas injection device of gas engine

(76) Inventors: Takayuki Yamamoto, Yokohama (JP); Shinji Yasueda, Yokohama (JP)

Correspondence Address: WENDEROTH, LIND & PONACK, L.L.P., 2033 K STREET N. W., SUITE 800, WASHINGTON, DC, 20006-1021, US

(21) Appl. No.: 10/120,487

(22) Filed: Apr. 12, 2002

(30) Foreign Application Priority Data
Apr. 13, 2001 (JP) 2001-115279
Nov. 2, 2001 (JP) 2001-337568

(51) Int. Cl. F02B 43/00

(52) U.S. Cl. 123/527

(57) ABSTRACT

A gas injection device in which an tunnel-like inner room is formed by surrounding with an inner wall, the inner room is communicated to the intake air flow passage of the intake pipe to allow the intake air to flow through the inner room, the inner wall is surrounded with an outer wall to form between the inner wall and outer wall an outer gas chamber into which fuel gas is introduced, and gas injection holes are provided in the inner wall to permit the gas in the outer gas chamber to sprout out from the injection holes into the air stream flowing through the inner room. The inner room may be partitioned into a plurality of tunnel-like rooms to correspond to the number of the intake air passages in the cylinder head.

### BACKGROUND OF THE INVENTION

1. Field of the Invention

The present invention relates to a gas injection device of a gas engine to inject the fuel gas into the intake air flowing through the intake pipe and mix the injected fuel gas with the flowing air for supplying the mixture to the combustion chamber.

2. Description of the Related Art

Many of gas engines using mainly clean gases such as town gas, etc. adopt pre-mixing type fuel supply method in which the fuel gas is injected into the intake air flowing in the intake pipe of the engine. The mixing of the fuel gas with the intake air is generally done by injecting the fuel gas from the fuel gas injection nozzle protruding in the flowing intake air in the intake pipe. A fuel gas injection device of pre-mixing type using such an gas injection nozzle is disclosed in Japanese Patent Application Publication No. 9-268923.

In the disclosure, a gas injection nozzle is protruding across the intake air passage in the intake pipe of the engine, and a plurality of injection holes are provided perpendicular to the axis of the gas injection nozzle and also to the axis of the intake pipe, the holes being opened in two directions opposite to each other. Accordingly, the fuel gas is injected into the flowing air in the intake pipe in the direction crossing the stream of air flow to attain perfect mixing of the gas fuel with the air in the air passage from there to the inlet port of the engine.

If the fuel gas is injected into the intake air just behind the inlet valve before the air flows into the cylinder, the fuel gas enters into the cylinder without mixed with the intake air sufficiently, variation in fuel/air ratio in the combustion chamber is produced, and local fuel rich mixtures are formed which cause knocking due to irregular combustion.

According to said disclosure in Japanese Patent Application No. 9-268923, the gas injection nozzle is provided at an upstream position of the intake pipe distant enough from the inlet valve, and knocking due to insufficient mixing of fuel with intake air is evaded. However, as the cylindrical gas injection nozzle protrudes into the intake pipe across the intake air passage, the cylindrical gas injection nozzle becomes the resistance to the intake air flow.

Accordingly, with the prior art mentioned above, pressure loss in supplying the intake air to the engine is increased due to the flow resistance at the gas injection nozzle, which reduces, particularly in the case with a supercharged engine, the positive pumping work done by the pressurized intake air resulting in reduced engine output.

### SUMMARY OF THE INVENTION

The present invention was done in light of the problem mentioned above. The object of the invention is to prevent the reduction in engine output through decreasing the flow resistance against the intake air flow at and near the gas injection nozzle in an engine equipped with a gas injection nozzle for injecting fuel gas into the intake air flowing in the intake pipe.

The invention provides to solve the problems mentioned above a gas injection device of gas engine in which

said injection nozzle section comprises an inner room of which the surrounding wall is provided with single or a plurality of injection holes and of which the upstream side opening and downstream side opening are communicated with said intake air passage, and an outer gas chamber formed between the inner wall surrounding said inner room and the outer wall surrounding said inner wall, the fuel gas being introduced to said outer gas chamber, and

the fuel gas introduced in the outer gas chamber via an adjusting valve for adjusting supply amount of the fuel gas is spouted into the inner room from the hole or holes provided in the inner wall.

Said inner room is preferably formed so that the cross section perpendicular to the center line of said intake air passage is of polygonal shape.

Concerning the configuration of a plurality of the injection holes in said gas injection nozzle section, it is preferable that each opening area of each of said injection holes is larger with increasing distance from the part at which said gas supply pipe is connected to said outer gas chamber.

It is suitable that the opening area of adjacent injection hole is different from each other in the direction of the air flow in a way in which the opening area of each of said injection holes is larger in upstream side, and also, for example, that said injection holes are slit-like holes extending in the direction along the sides of said polygon and the width of each of the holes is larger with increasing distance from the part at which said gas supply pipe is connected to said outer gas chamber.

It is also suitable that all of said injection holes have the same opening area, and further, that said injection holes are provided in two side walls of said inner wall parallel to the center line of the opening to which said gas supply pipe is connected.

Further, it is suitable, in the gas injection device of a gas engine having a plurality of intake air passages in the cylinder head to guide the air into the combustion chamber, that said inner room is partitioned with partition wall or walls into a plurality of sections corresponding to the number of intake air passages in the cylinder head, and each section is communicated with each of said intake air passages in the cylinder head, and preferably that single injection hole is provided in each side wall of each section, each of the side walls facing the outer gas chamber.

It may be suitable that said outer gas chamber is provided with a plurality of gas entrance openings to be connected with gas supply pipes.

A concrete configuration of this is that an upstream header having a certain internal volume is provided on said gas supply pipe line, and the upstream header is connected to said outer gas chamber with a plurality of gas supply branch pipes.

Concerning said location of said gas supply adjusting valve, the adjusting valve for adjusting the supply amount of gas fuel is provided on the gas supply pipe line at the upstream side of said upstream side header, or the adjusting valve may be provided on each of the gas supply branch pipe lines.

Further, it is suitable that said gas injection nozzle section is provided in each of the intake air branch pipe lines which branch off from a main intake air pipe to be connected to each cylinder of an engine.

According to the invention, the upstream side opening and down stream side opening of the inner room are formed into the same shape in cross section to be communicated with the intake pipe, and the fuel gas is allowed to jet from a plurality of injection holes into the inner room. So an object which disturbs the intake air flow to increase flow resistance is eliminated from the intake air passage, and the intake air flows smoothly through the inner room of the same cross section as that of the intake pipe while the fuel gas injected from the injection holes provided in the surrounding wall of the inner room mixes with the flowing air in the inner room and downstream therefrom.

By this configuration of a gas injection nozzle section, the intake air flow loss at the section where the gas injection nozzle is located, is eliminated or minimized, and the reduction in engine output due to the reduction of the positive pumping work done by the intake air in the case of a supercharged engine is prevented because of the reduced intake air flow loss.

Further, as fuel gas is injected simultaneously from the multiple injection holes arranged in the peripheral wall of the inner room which the intake air flows through, the fuel gas mixes uniformly with the air passing through the inner room and the mixture of uniform fuel/air ratio can be supplied to the combustion chamber of the engine. Accordingly, poor combustion or the occurrence of knocking due to the nonuniform fuel/air ratio of mixture is prevented.

Further, if said multiple injection holes 3 are arranged so that the opening area of each holes belonging to the same column is larger as the distance increases from each hole belonging to the row located nearest to the opening at which the gas supply pipe is connected to the outer gas chamber toward the opposite side. Therefore, concerning the holes belonging to the same column, the smallest hole is located near the opening at which the gas supply pipe is connected to the outer gas chamber and the holes is larger as the distance from the opening is remoter. As a result, the quantity of gas injection from each hole of the same column into the inner room is equalized, which causes uniform mixing of the fuel gas with the air.

Further, if the multiple injection holes are arranged so that the opening area of each holes belonging to the same row is larger in the upstream, that is, concerning the opening area of each hole of the same row, the hole of upstream side column is larger than that of downstream side column.

Therefore, the gas streams spouting from the holes of larger opening area located in the upstream side reach the center part of the inner room and air passage of the intake pipe which communicates with the inner room, and the streams spouting from the holes of smaller opening area located in the downstream side do not reach the center part but they flow nearer the wall of the inner room and the intake pipe connected to the inner room. As a result, the fuel gas spouting from the holes can be supplied evenly into the inner room and the flow passage of the intake pipe, which causes uniform mixing of fuel gas with air.

When a plurality of gas entrance openings to introduce the gas into the outer gas chamber are provided symmetrically with regard to the center line of the inner room or when gas pipes of small diameter are connected to the outer gas chamber so that the uniformity of gas pressure in the outer gas chamber is not influenced by the positions of the gas supply pipe connection to the outer gas chamber, it is suitable to provide the injection holes of the same opening area. In this case, diameters of all the holes are the same and the holes can be drilled with drills of the same diameter resulting in reduction of machining man-hours.

When single entrance opening to introduce the fuel gas into the outer gas chamber is provided, or when gas supply pipes of small diameter are used so that the gas pressure does not vary according to the place in the outer gas chamber, it is better for evading unevenness in injection quantity between that in the upper side and that in the lower side of the inner room and for attaining uniform mixing of the fuel gas with the air to provide the holes only in the two side walls parallel to the center line of the entrance opening.

When a plurality of entrance openings are provided in the outer wall of the outer gas chamber, the fuel gas is introduced into the outer gas chamber from multiple directions, so the pressure in the outer gas chamber becomes uniform, which leads to uniform supply of the fuel gas to each injection hole.

In this case, by providing an upstream header in the upstream side of the gas injection nozzle section, the fuel gas supply pressure is equalized in the upstream header, and the flow rates of the fuel gases in gas supply branch pipes for supplying the fuel gas form the upstream header to the outer gas chamber of the gas injection nozzle section are equalized.

By providing each of the gas supply branch pipes with an electromagnetic gas supply valve, the injection response at the gas injection nozzle section in response to the openings of the electromagnetic gas supply valve is improved.

Further, by providing the gas injection nozzle section having a gas supply adjusting valve per each cylinder, the fuel gas flow is adjusted for each cylinder by the gas supply adjusting valve. Therefore, the mixture of fuel gas with air mixed in each gas injection section is supplied to each cylinder, and the fuel/air ratio of the mixture in each cylinder is equalized.

In the case of the gas injection device applied to an engine having a plurality of intake air passage in the cylinder to guide the air into the combustion chamber, it is inevitable for improving combustion efficiency and preventing abnormal combustion such as knocking to equalize the fuel/air ratios in the passages in the cylinder to evade uneven mixture in the combustion chamber.

In order to solve the problem like this, said inner room is partitioned with partition wall or walls into a plurality of sections corresponding to the number of the intake air passages in the cylinder head to guide the air into the combustion chamber, and each section is communicated with each of said intake air passage in the cylinder head. By this configuration, the uniform mixture can be supplied by single gas injection device even in the case of an engine with two or more intake air passages formed in the cylinder to guide the air into a combustion chamber as shown in FIG. 22 and FIG. 21.

FIG. 23 represents a simulation result of the mixing sates of fuel gas with air in this case.

In the case with small diameter multiple injection holes (upper frame in FIG. 13), fuel gas exists only near the side wall at the early stage of 0 position, it is diffused at the partway (90° position), however, with the zone remaining in the center part where the fuel gas concentration is high, and uneven mixing state is observed even at the end position (180° position) from where the mixture enters into the combustion chamber. Therefore, the improvement in combustion efficiency and the prevention of abnormal combustion such as knocking may not be possible.

On the other hand, in the case with a large diameter injection hole provided in each of the side wall facing the outer gas chamber(total 4 injection holes) shown in the lower frame in FIG. 23, the fuel gas is mixed with the air at the initial stage of 0° position, it is further diffused at the partway (90° position) without the zone of high fuel gas concentration in the center part, and the mixture is even in fuel gas concentration at the end position (180° position) from where the mixture enters into the combustion chamber.

Therefore, the combustion efficiency is improved and abnormal combustion such as knocking is prevented.

In the latter case, even in case the pressure of gas supply is not high enough in the gas injection device of an gas engine having a plurality of inlet air passages in the cylinder to guide the air into the combustion chamber, the mixing of fuel gas with intake air is promoted.

### BRIEF DESCRIPTION OF THE DRAWINGS

FIG. 1 is a longitudinal sectional view along the center line of the intake pipe (section along line Z-Z in FIG. 17 and section along line Y-Y in FIG. 18) showing the structure of a first embodiment of the gas injection device according to the present invention.

FIG. 2 is a cross-sectional view along line A-A in FIG. 1.

FIG. 3 is a cross-sectional view along line B-B in FIG. 2.

FIG. 4 is a cross-sectional view along line C-C in FIG. 2.

FIG. 5 is a cross-sectional view of a second embodiment and corresponds to FIG. 2 of the first embodiment(corresponds to the cross-sectional view along line A-A in FIG. 1).

FIG. 6 is a cross-sectional view of a third embodiment and corresponds to FIG. 2 of the first embodiment(corresponds to the cross-sectional view along line A-A in FIG. 1).

FIG. 7 is a cross-sectional view along line D-D in FIG. 6.

FIG. 8 is a cross-sectional view along line E-E in FIG. 6.

FIG. 9 is a cross-sectional view along line F-F in FIG. 6.

FIG. 10 is a cross-sectional view of a fourth embodiment and corresponds to FIG. 2 of the first embodiment(corresponds to the cross-sectional view along line A-A in FIG. 1).

FIG. 11 is a cross-sectional view of a fifth embodiment and corresponds to FIG. 2 of the first embodiment(corresponds to the cross-sectional view along line A-A in FIG. 1).

FIG. 12 is a cross-sectional view along line G-G in FIG. 11.

FIG. 13 is a cross-sectional view along line H-H in FIG. 11.

FIG. 14 is a cross-sectional view along line I-I in FIG. 11.

FIG. 15 is a plan view of a sixth embodiment.

FIG. 16 is a plan view of a seventh embodiment.

FIG. 17 is a plan view showing a first example of the placement of the gas injection section.

FIG. 18 is a plan view showing a second example of the placement of the gas injection section.

FIG. 19 is a cross-sectional view explaining the working of the gas injection section.

FIG. 20 is a schematic view showing the configuration of intake system of an engine to which the present invention is applied.

FIG. 21 is a schematic view showing an example of location of the gas injection nozzle in the case of an engine having a plurality of intake passages in the cylinder head for introducing the intake air into the cylinder by way of a plurality of intake valves.

FIG. 22(A) is a cross-sectional view along line J-J in FIG.21, and

FIG. 22(B) is a cross-sectional view along line K-K in FIG.22(A).

FIG. 23 represents pictures showing the simulation result of mixed state of fuel gas with air, comparing the case where multiple injection holes of small diameter are provided (upper pictures) with the case where single injection hole of large diameter is provided per each side of right and left for one intake passage totaling to 4 injection holes (lower picture), with the same total opening area of the injection holes in both cases.

### DETAILE DESCRIPTION OF THE PREFERRED EMBODIMENTS

A preferred embodiment of the present invention will now be detailed with reference to the accompanying drawings. It is intended, however, that unless particularly specified, dimensions, materials, relative positions and so forth of the constituent parts in the embodiments shall be interpreted as illustrative only not as limitative of the scope of the present invention.

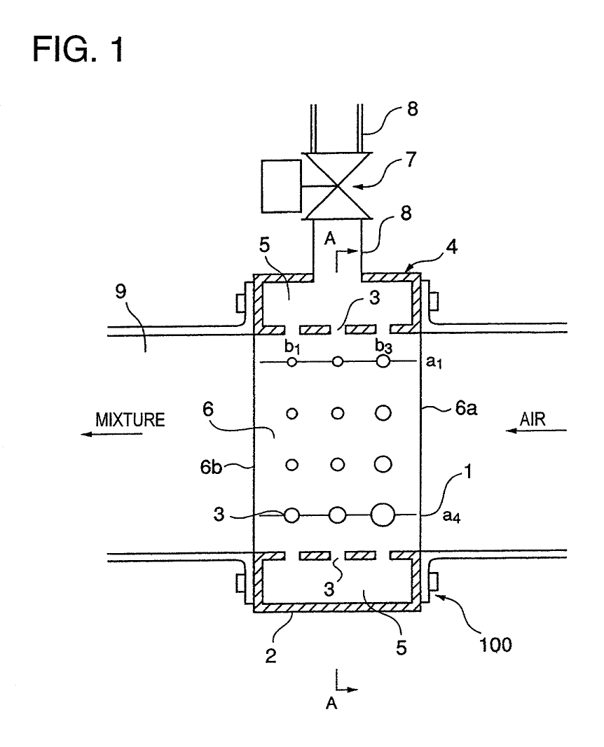

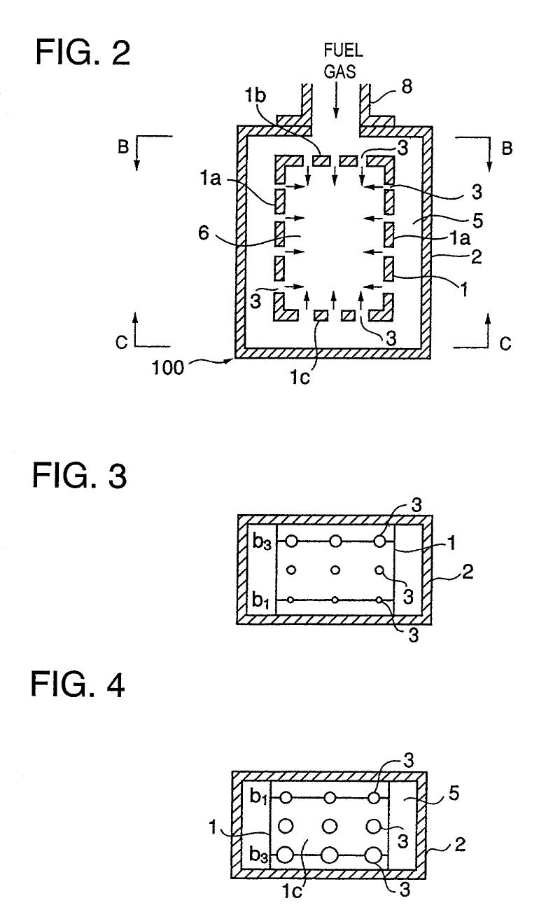

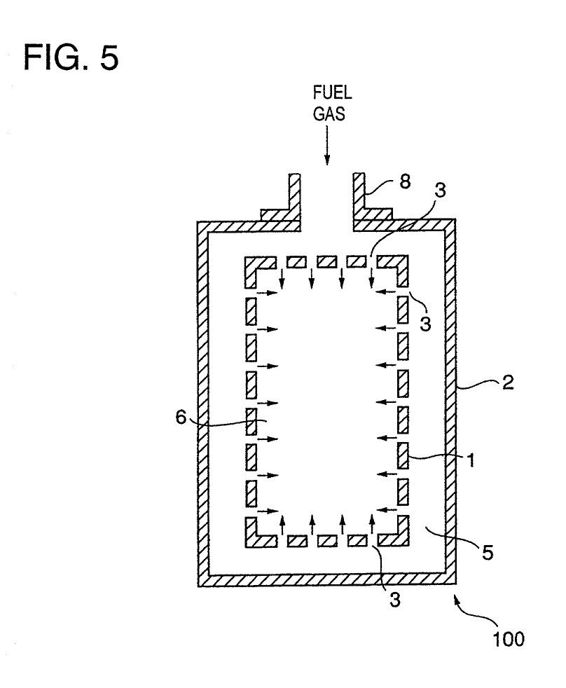

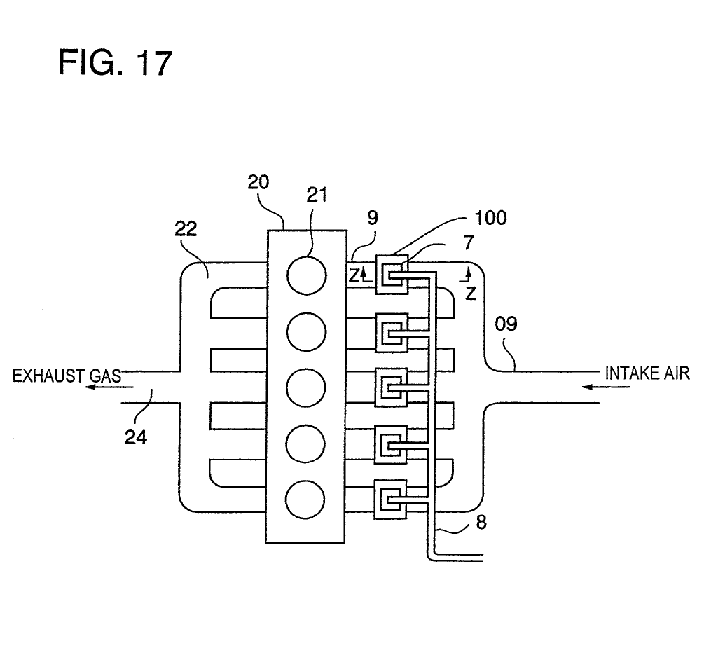

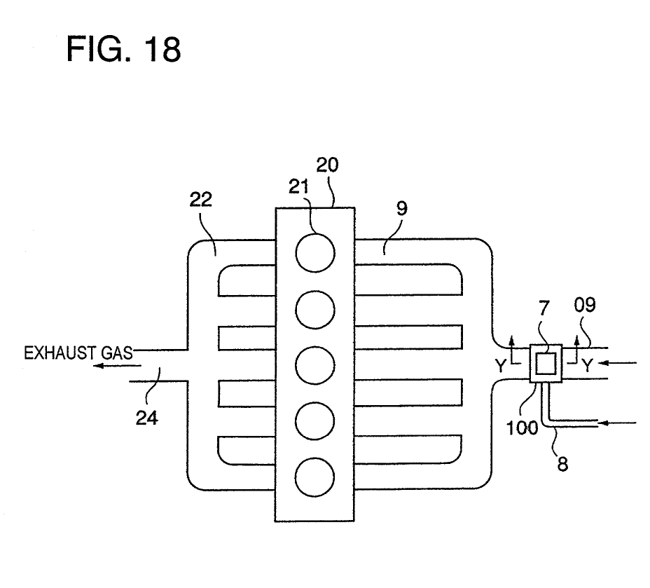

FIG. 1 is a longitudinal sectional view along the center line of the intake pipe (section along line Z-Z in FIG. 17 and section along line Y-Y in FIG. 18) showing the structure of a first embodiment of the gas injection device according to the present invention, FIG. 2 is a cross-sectional view along line A-A in FIG.1, FIG. 3 is a cross-sectional view along line B-B in FIG. 2, and FIG. 4 is a cross-sectional view along line C-C in FIG. 2. FIG. 5 is a cross-sectional view of a second embodiment and corresponds to FIG. 2 of the first embodiment(corresponds to the cross-sectional view along line A-A in FIG. 1).

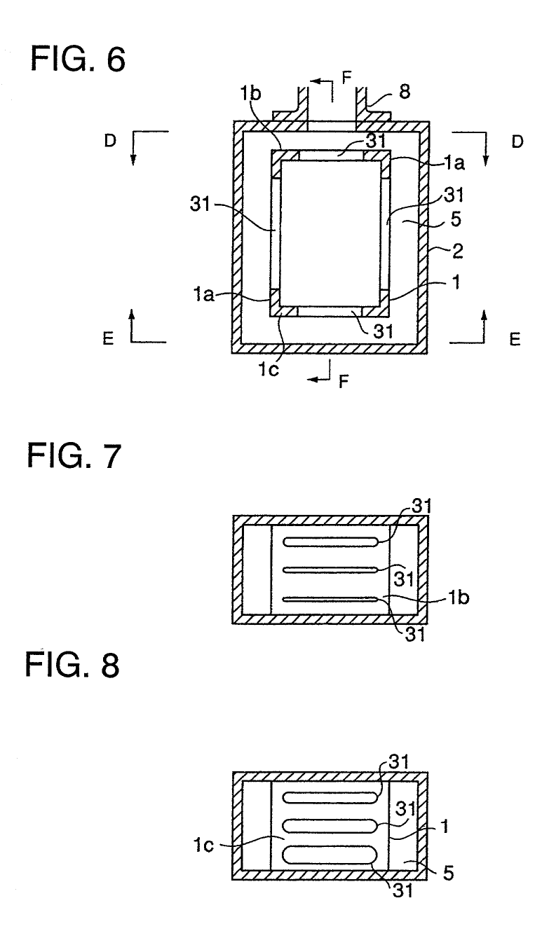

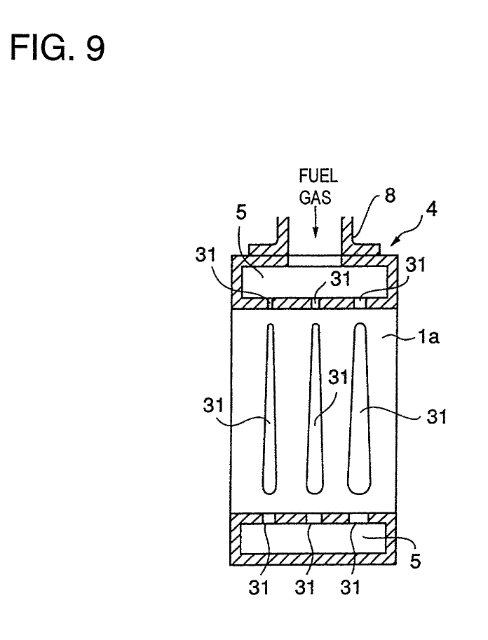

FIG. 6 is a cross-sectional view of a third embodiment and corresponds to FIG. 2 of the first embodiment, FIG. 7 is a cross-sectional view along line D-D in FIG. 6, FIG. 8 is a cross-sectional view along line E-E in FIG. 6, and FIG. 9 is a cross-sectional view along line F-F in FIG. 6.

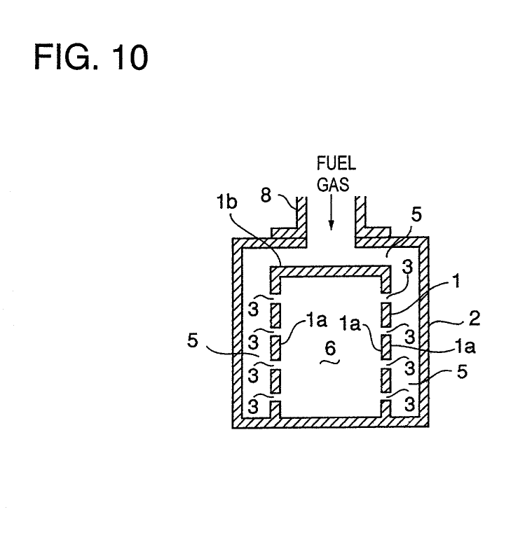

FIG. 10 is a cross-sectional view of a fourth embodiment and corresponds to FIG. 2 of the first embodiment.

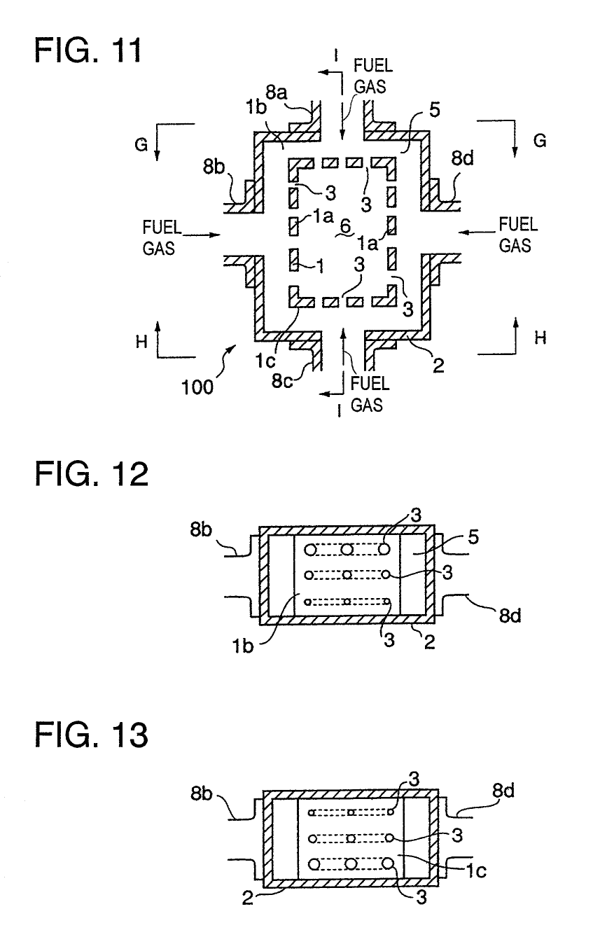

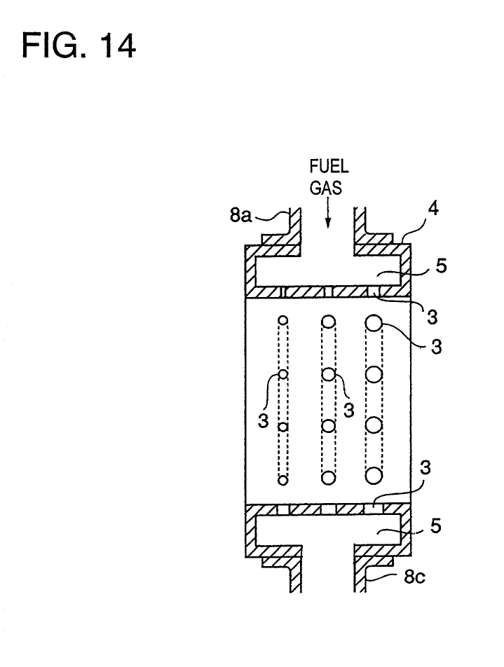

FIG. 11 is a cross-sectional view of a fifth embodiment and corresponds to FIG. 2 of the first embodiment, FIG. 12 is a cross-sectional view along line G-G in FIG. 11, FIG. 13 is a cross-sectional view along line H-H in FIG. 11, FIG. 14 is a cross-sectional view along line I-I in FIG. 11.

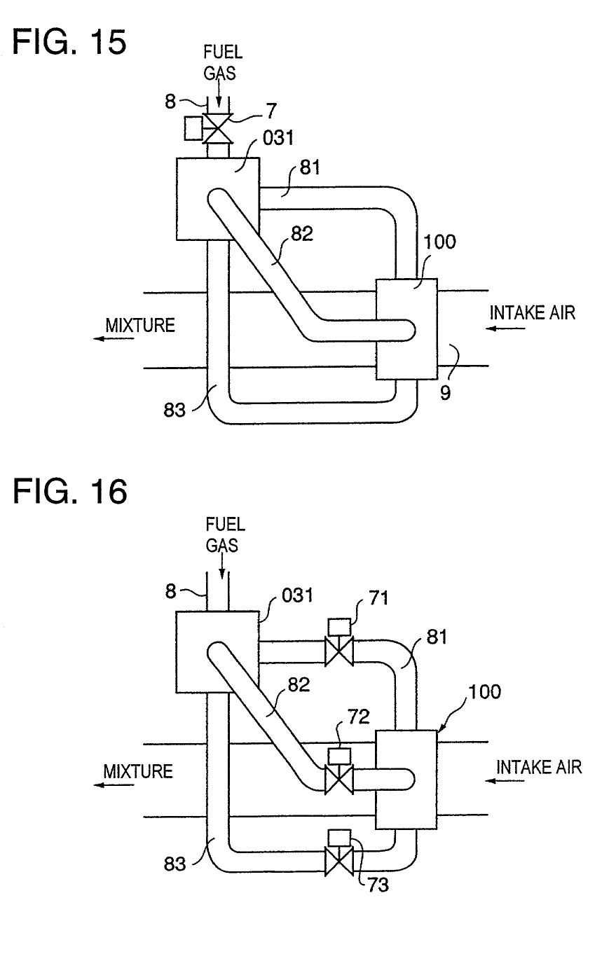

FIG. 15 is a plan view of a sixth embodiment, FIG. 16 is a plan view of a seventh embodiment. FIG. 17 is a plan view showing a first example of the placement of the gas injection section, FIG. 18 is a plan view showing a second example of the placement of the gas injection section.

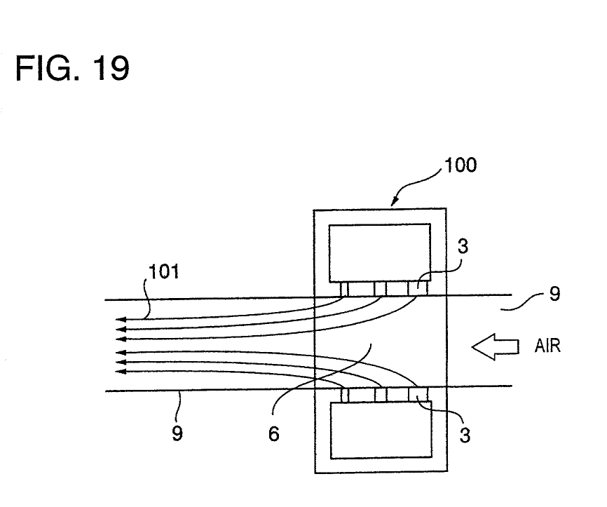

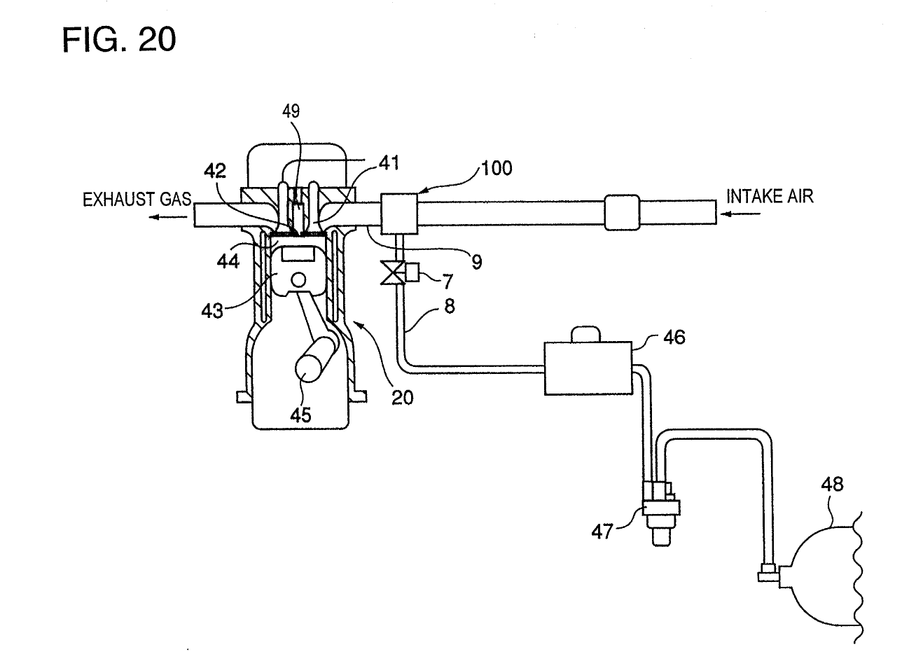

FIG. 19 is a cross-sectional view explaining the working of the gas injection section. FIG. 20 is a schematic view showing the configuration of intake system of an engine to which the present invention is applied.

In FIG. 20 showing the configuration of the intake system of an engine to which the present invention is applied, reference numeral 20 is an engine proper, 43 is a piston, 45 is a crankshaft, 44 is a combustion chamber, 41 is an inlet valve, and 42 is an exhaust valve.

Reference numeral 9 is an intake pipe to which a gas injection nozzle section 100 is connected to inject fuel gas into the intake air flowing in the intake pipe 9. Reference numeral 48 is a fuel gas tank containing the fuel gas to be supplied to the gas injection nozzle section 100, and 8 is a gas supply pipe connecting the fuel gas tank 48 to the gas injection nozzle section 100.

Reference numeral 47 is a gas pressure adjuster for adjusting the fuel gas pressure, and 46 is a gas valve to open/close the passage of the gas supply pipe 8. Reference numeral 49 is an ignition device which torch-ignites the fuel rich mixture in the sub-chamber to promote the combustion of the fuel lean mixture in the main combustion chamber.

This configuration is the same as that of the conventional pre-mixing type gas engine. In the present invention, the gas injection device including the gas injection nozzle 100 attached to the intake pipe 9 and the system for supplying fuel gas to the gas injection nozzle section 100 is improved.

The gas injection nozzle section 100 is formed to have a quadrangular section for matching to the shape of the section of the intake pipe 9 as shown in FIG. 1 to FIG. 4, in which reference numeral 6 is an inner room surrounded with an inner wall 1, and the upstream side opening 6a and down stream side opening 6b are of the same shape as the section of the intake pipe 9 to be communicated to the inlet pipe 9.

An outer gas chamber 5 of quadrangular ring shape section is formed between an outer wall 2 and the inner wall 1 as shown in FIG. 2. The gas supply pipe 8 from the fuel gas tank 48(see FIG. 20) is connected to the header part at the upper part of the outer gas chamber 5.

A gas supply electromagnetic valve 7 provided at the inlet of the header part of the gas supply pipe 8 adjusts the quantity of the gas which passes through the gas supply pipe 8 through changing the valve opening in accordance with the control signal from an electromagnetic valve control device not shown in the drawings. The shape of the cross section of the gas injection nozzle section 100 is formed in quadrangular shape in the embodiment, however, the cross section may be of variety of shapes other than a quadrangular shape such as polygonal shape, circular shape, etc.

Reference numeral 3 are a plurality of gas injection holes drilled in the inner wall 1 to communicate the outer gas chamber 5 with the inner room 6.

In the first embodiment, these injection holes 3 are formed in the four sides of the inner wall 1 as shown in FIG. 2 and arranged in a plurality of columns and rows as shown in FIG. 1, 3, and 4(in the example, 3 columns and 4 rows in the side wall, and 3 columns and 3 rows in the upper/lower wall). The injection holes 3 provided in the side walls la(FIG.2) of the inner wall 1 and belonging to the same column are larger in diameter, i.e. larger in opening area as the distance from al row near the header part, at which the gas supply pipe 8 is connected to the outer gas chamber, increases toward a4 row, and the holes belonging to the same row are larger in diameter in the upstream side column b3 than in the down stream side column b1, resulting in that the opening areas of adjacent hole are different from each other.

Injection holes 3 arranged along the flow passage of the intake air in the upper plate 1b of the inner wall 1 near said head part 4 where an opening is provided to be connected with said gas supply pipe 8, are smaller in diameter than injection holes 3 arranged along the flow passage of the intake air in the lower plate 1c of the inner wall 1 located opposite to the upper plate across the inner room 6, as shown in FIG. 3 and FIG. 4.

In the gas engine equipped with the gas injection device of the configuration like this, torch-ignition is done in said ignition device 49, and when said gas valve 46 is open the fuel gas in said fuel gas tank 48 is supplied to said gas injection nozzle section 100, the gas being adjusted in pressure by said gas pressure adjusting device 47. The gas is injected into the air passing through the intake pipe 9 at the gas injection nozzle section 100 to be mixed with the air as explained later. The fuel gas/air mixture is introduced into the combustion chamber 44 through the inlet valve 41, ignited by the flame jet from the ignition device 49.

When the gas supply electromagnetic valve 7 is opened under the signal from an electromagnetic valve controller not shown in the drawings, the fuel gas enters into the outer gas chamber 5 at the header part 4 to fill the outer gas chamber 5, and injected into the inner room 6 through a plurality of injection holes 3 formed in the inner wall 1, as shown in FIG. 1˜4.

The fuel gas injected from the injection holes 3 into the inner room 6 mixes with the intake, while riding on the air stream flowing in the intake air pipe 9 communicating with the inner room 6 toward the inlet valve 41 (see FIG. 20), and the fuel gas/air mixture is introduced into the combustion chamber through the inlet port to be burned.

With this embodiment, the upstream side opening 6a and down stream side opening 6b of the inner room 6 are formed to the same shape in cross section to communicate with the intake pipe 9, and the fuel gas is allowed to spout from a plurality of injection holes 3 into the inner room 6, so an object which disturbs the intake air flow and increases flow resistance is eliminated from the intake air passage. Therefore, the intake air flows smoothly through the inner room 6 of the same cross section as that of the intake pipe 9 while mixing with the fuel gas injected from the holes provided in the surrounding wall of the inner room 6 in the inner room and downstream therefrom.

By this configuration of the gas injection nozzle section 100, the intake air flow loss in the gas injection nozzle section 100 is eliminated or minimized, and the reduction in engine output due to the reduction of the positive pumping work done by the intake air in the case of a supercharged engine is prevented because of reduced intake air flow loss.

Further, as fuel gas is injected simultaneously from the multiple injection holes 3 arranged in the peripheral wall of the inner room 6 which the intake air flows through, the fuel gas mixes uniformly with the air passing through the inner room and the mixture of uniform fuel/air ratio can be supplied to the combustion chamber 44 of the engine. Accordingly, poor combustion or the occurrence of knocking due to nonuniform fuel/air ratio of the mixture is prevented.

Further, said multiple injection holes 3 are arranged so that the opening area of each holes belonging to the same column is larger as the distance increases from each hole belonging to row al toward that belonging to row a4, row al being located near the header part 4 at the opening at which the gas supply pipe 8 for supplying the gas to the outer gas chamber 5 is connected.

Therefore, concerning the holes belonging to the same column, the smallest hole is located near the opening of the gas supply pipe 8 into the outer gas chamber and the holes is larger as the distance from the opening is remoter. As a result, the quantity of gas injection from each hole of the same column into the inner room 6 which communicates with the intake pipe 9 is equalized, which causes uniform mixing of fuel gas with air.

Further, the multiple injection holes 3 are arranged in the upper/lower wall of the inner wall 1 so that the opening area is larger in the upstream side holes, that is, the holes of row b3 is larger than those of row b1. Therefore, as shown in FIG. 19, among fuel gas streams 101 spouting from the holes, streams spouting from the holes of larger opening area located in the upstream side reach the center part of the inner room 6 and the intake pipe 9 which communicates with the inner room, and streams spouting from smaller opening area located in the downstream side do not reach the center part but they flow near side to the wall of the inner room 6 and the intake pipe 9 which communicates with the inner room. As a result, the fuel gas spouting from the holes 3 can be supplied evenly into the inner room 6 and the flow passage of the intake pipe 9, which causes uniform mixing of fuel gas with air.

FIG. 5 shows a second embodiment of the present invention in which all injection holes 3 drilled in the inner wall 1 of the gas nozzle 100 are the same in diameter, i.e. the same in opening area. The configuration other than this is the same as that of the first embodiment shown in FIG. 1˜FIG. 4, and the similar element as in the first embodiment is marked with the same reference numerals.

The embodiment lends itself to applications such that a plurality of gas supply pipes 8 opens into the outer gas chamber 5 at positions symmetric with respect to center lines of the inner room as illustrated in FIGS. 11˜14, or such that gas supply pipes of small diameter are used so that the uniformity of gas pressure in the outer gas chamber is not influenced by the positions of the gas supply pipe connection to the outer gas chamber.

With the embodiment, diameters of all the holes are the same and the holes can be drilled with drills of the same diameter resulting in reduction of machining man-hours.

A third embodiment of the present invention is represented in FIG. 6˜FIG. 9, in which injection holes 31 of slit-like shape are formed extending in the direction along the sides of the quadrangle of inner wall 1 of the gas nozzle section 100.

The width of each injection holes 31 formed in the side plate 1a of said inner wall 1 increases with distance from the header part 4 where said gas supply pipe 8 opens as shown in FIG. 9.

The width of each injection holes 31 formed in the upper plate 1b and lower plate 1c is larger in the upstream side as shown in FIG. 7, and FIG. 8. The configuration of the embodiment is the same as that of the first embodiment except the difference mentioned above, and the similar element as in the first embodiment is marked with the same reference numeral. In the embodiment also the similar effect as the first embodiment is attained.

A fourth embodiment is shown in FIG. 10, in which a plurality of injection holes are arranged in two parallel side plates 1a of the inner room parallel to the center line of the opening at which the gas supply pipe 8 is connected to the outer gas chamber, no injection hole is provided in the upper plate 1b, and the inner room has no lower plate of its own but the lower plate is common with the lower plate of the outer gas chamber. Said injection holes 3 may be of the same diameter as the first embodiment shown in FIG. 5 or of different diameters as the first embodiment shown in FIG. 1˜4.

The configuration of the embodiment is the same as that of the first embodiment except the difference mentioned above, and the similar element as in the first embodiment is marked with the same reference numeral. When single opening is provided for the connection with the gas supply pipe, it is better to provide the injection holes 3 only in the two side face parallel to the center line of the opening for evading nonuniformity in the injection quantity which may be caused if the injection holes are provided in the upper/lower plate of the inner room 6, resulting in uniform injection quantity of the fuel gas.

A fifth embodiment of the present invention is shown in FIG. 11˜FIG. 14, in which openings 8a, 8b, 8c, 8d are provided in each side of the outer wall 2 to supply fuel gas into the outer gas chamber 5 byway of the gas supply pipes 8. Injection holes are larger in diameter, i.e. in the opening area in the upstream side than in the downstream side like in the first embodiment. The configuration of the embodiment is the same as that of the first embodiment except the difference mentioned above, and the similar element as in the first embodiment is marked with the same reference numeral.

With the embodiment, the fuel gas is introduced into the outer gas chamber 5 from four sides, so the pressure is even around the inner wall 1 surrounding the inner room 6 in the outer gas chamber 5, which permits the same pressure condition for the fuel gas in the outer gas chamber to enter the injection holes to be spouted out into the air stream.

A sixth and seventh embodiments of the present invention are shown in FIG. 15 and FIG. 16 respectively, in each of which is provided a upstream side header 031 having a certain internal volume to which a gas supply pipe 8 is connected, and gas supply branch pipes 81, 82, and 83 are provided to connect the upstream side header 031 to the openings 8a, 8b, and 8c respectively of the gas injection nozzle section 100 of the fifth embodiment shown in FIG. 11˜FIG. 14. A gas supply branch pipe not shown in the drawing may be provided to connect the upstream header 031 to the opening 8d of the gas injection nozzle section 100.

A gas supply electromagnetic valve 7 is provided on the gas supply pipe 8 at the entrance to the upstream side header 031 in the sixth embodiment as shown in FIG. 15. Each of the gas supply branch pipe 81, 82, and 83 is provided with a gas supply electromagnetic valve 71, 72, and 73 respectively in the seventh embodiment as shown in FIG. 16.

According to the sixth or seventh embodiment with the upstream header 031 provided upstream-side the gas injection nozzle section 100, the fuel gas of equal pressure is supplied to said gas injection nozzle section 100 by way of the gas supply branch pipe 81, 82, and 83, and the flow rate of the fuel gas flowing in each gas supply branch pipe 81, 82, and 83 is equal.

According to the seventh embodiment, each of the gas supply pipes 81, 82, and 83 is provided-with an electromagnetic gas supply valve 7, so the injection response at the gas injection nozzle section 100 is good in response to the openings of the electromagnetic gas supply valve 7.

FIG. 17 shows a first example of the location of the gas injection device, in which each of the gas injection nozzle section 100 provided with the gas supply electromagnetic valve 7 and connected to the gas supply pipe 8 is attached to each intake air branch pipe 9 which branches off from an intake air main pipe 09 to be connected to each cylinder 21.

In this example, gas fuel flow rate is adjusted for each cylinder 21 by each gas supply electromagnetic vale 7 equipped to each gas injection nozzle section 100 which is attached to each intake air branch pipe 9, so the fuel gas/air mixture of which the fuel flow rate is adjusted by the valve 7, is supplied to the combustion chamber 44 of each cylinder 21. Therefore, the fuel/air ratio of the mixture in the cylinder 21 is equalized in all cylinders, good combustion is attained, and knocking is prevented.

FIG. 18 shows a second example of the location of the gas injection device, in which the gas injection nozzle section 100 equipped with the gas supply electromagnetic valve 7 connected to the gas supply pipe 8 is attached to the main air intake pipe 09.

In this case, the fuel/air ratio of the mixture in the cylinder is equalized in all cylinders, and occurrence of variation in combustion is suppressed.

In FIG. 17, 18, reference numeral 22 denotes an exhaust manifold, and 24 denotes an exhaust pipe.

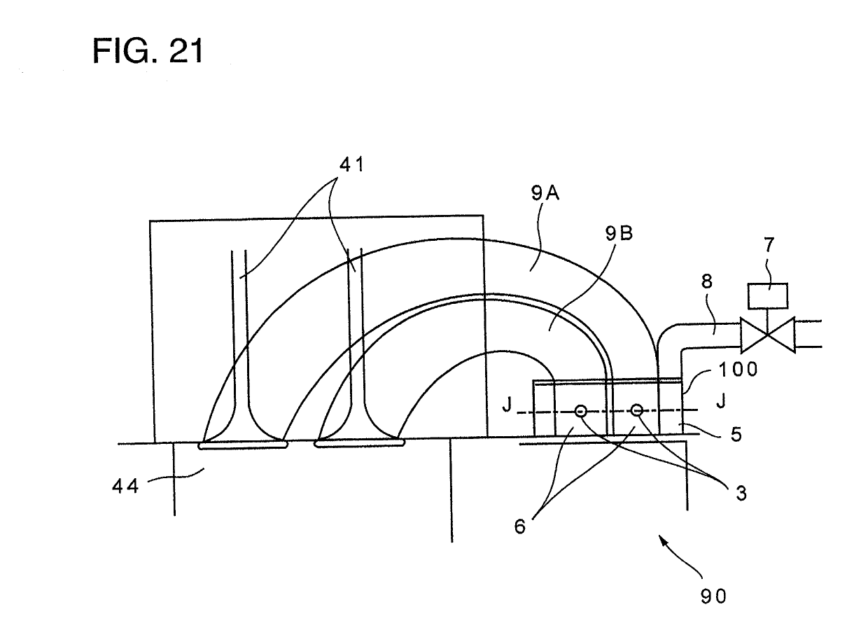

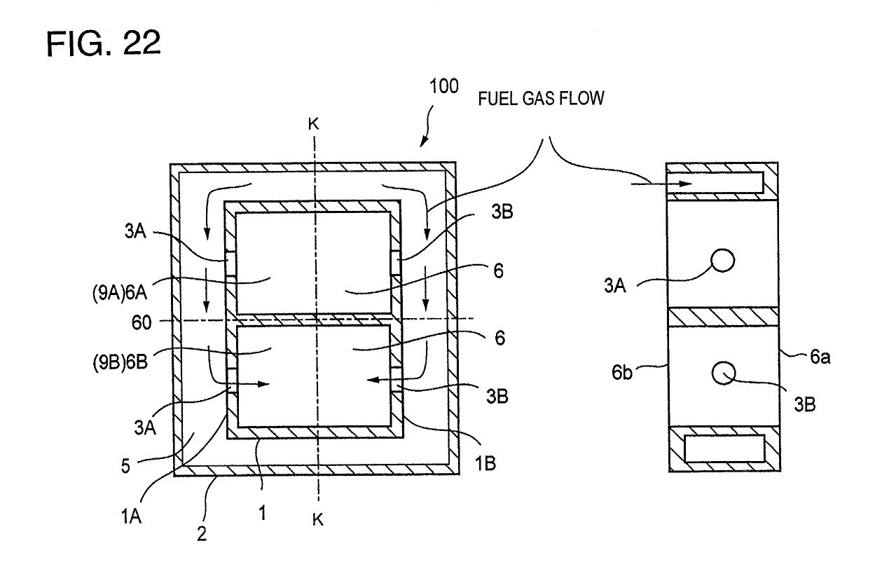

FIG. 21 and FIG. 22 show an eighth embodiment of the gas injection device in the case of an engine having a plurality of intake passages for introducing the intake air into the cylinder by way of a plurality of intake valves, FIG. 22(A) is a cross-sectional view along line J-J in FIG. 21, and FIG. 22(B) is a cross-sectional view along line K-K in FIG. 22(A).

In FIG. 21, the gas engine has two inlet valves 41, 41 and two intake air passages 9A, 9B in the cylinder head, and is provided with a gas injection nozzle section 100 between the main intake air passage 90 and the intake air passage 9A, 9B for injecting fuel gas into the air flowing in these passages 9A, 9B. Reference numeral 8 is a gas supply pipe connecting the gas injection nozzle section 100 to the fuel gas tank 48 (see FIG. 20), and 7 is a n electromagnetic gas supply valve attached to the gas supply pipe 8, the opening of the valve being able to be changed under the control signal from an electromagnetic valve controlling device not shown in the drawing to adjust the amount of the fuel gas which passes through the gas supply pipe 8.

In FIG. 22 which shows an eighth embodiment of the gas injection nozzle section, the gas injection nozzle section 100 has two adjoining quadrangular cross sections to match with the shape of the cross section of the intake pipe 9 at the one side thereof and match with the shape of the cross sections of the inlet passages 9A, 9B at the entrance thereof at the other side of the nozzle section 100, and configured as follows:

An outer gas chamber 5 of quadrangular ring shape is formed between an outer wall 2 and an inner wall 1. The inner room 6 surrounded by the inner wall 1 is divided in two rectangular rooms 6A, 6B with a partition wall 60, each room 6A, 6B communicating with each of the intake air passage 9A, 9B respectively at the rectangular entrance thereof. Both side wall 1A, 1B of each of the inner room 6A, 6B is provided with single injection hole 3A, 3B respectively. The gas injection nozzle section 100 is connected to the intake air passages at downstream side openings 6b of the inner room 6A, 6B.

With this embodiment, fuel gas can be supplied to the combustion chamber 44 having two or more intake air passage 9A, 9B through single gas injection nozzle section 100.

In the embodiment, the spouting gas streams from four injection holes 3A, 3B, each having large opening area, have stronger penetrating force than those spouting from holes of smaller opening area, and the mixing of fuel gas with the air passing through there is promoted when the gas supply pressure is low.

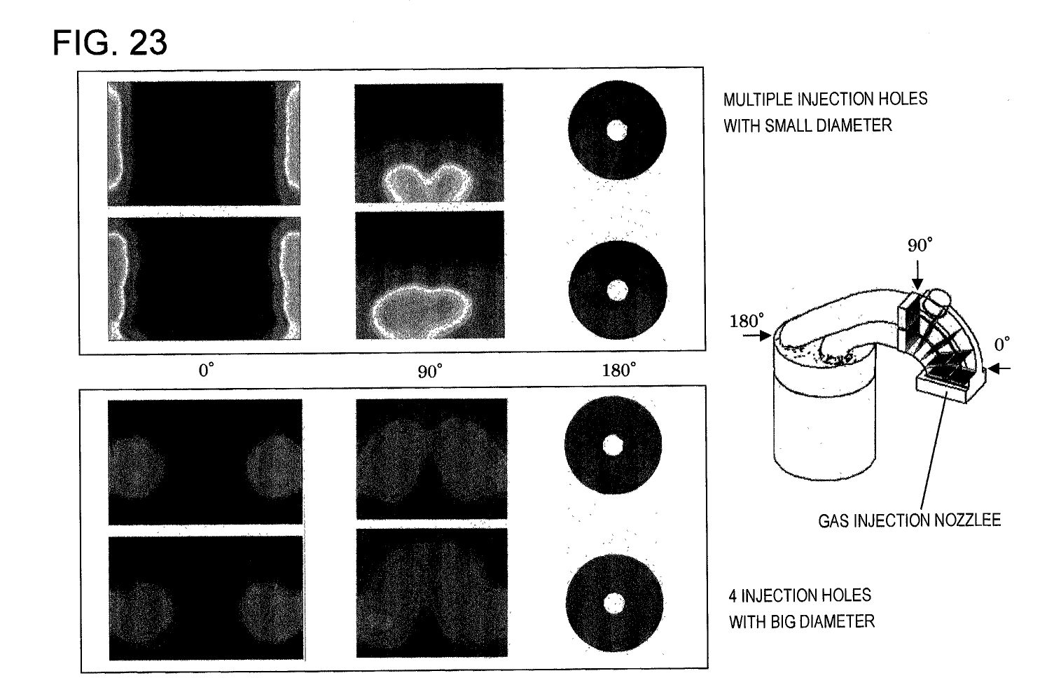

FIG. 23 represents the result of simulation of fuel gas/air mixing state comparing the case with large injection hole (single hole of large diameter in each of the side wall of each intake air passage totaling to four holes and shown in the lower frame) with the case with multi injection holes with small diameter (shown in the upper frame), total opening area in both cases being the same which is determined in consideration of gas supply pressure, gas fuel flow rate required, and the gas fuel injection period.

In the case of the example for comparison shown in the upper frame of FIG. 23, the penetration force of the fuel gas is weak because of the low pressure of gas supply, the fuel gas gathers near the side wall at 0° position, at an early stage after injection, and the mixing state is worse even at 180° position compared with that of the case of the example of the embodiment shown in the lower frame of FIG. 23. In the lower frame of FIG. 23, the mixing state is promoted compared with the case of said example for comparison because of the stronger penetration force of the gas fuel due to the large diameter of each injection hole.

It is recognized from the pictures in the upper frame of FIG. 23 that, in the case of the example for comparison, fuel gas exists only near the side wall at the early stage of 0° position, it is diffused at the partway (90° position), however, with the zone remaining in the center part where the fuel gas concentration is high, and uneven mixing state is observed even at the end position (180° position) from where the mixture enters into the combustion chamber. Therefore, the improvement in combustion efficiency and the prevention of abnormal combustion such as knocking may not be possible.

On the other hand, in the case of the example of the embodiment shown in the lower frame in FIG. 23, the fuel gas is mixed with the air at the initial stage of 0° position, it is further diffused at the partway (90° position) without the zone of high fuel gas concentration in the center part, and the mixture is even in fuel gas concentration at the end position (180° position) from where the mixture enters into the combustion chamber. Therefore, the combustion efficiency is improved and abnormal combustion such as knocking is prevented.

As mentioned above, it is understood that, when the gas supply pressure is low, the mixing state is improved by enlarging the opening area of the injection holes. So according to the present invention, the mixing of fuel gas with intake air is promoted even in case the pressure of gas supply is not high enough.

As has been described in the foregoing, according to the present invention, the object which cause flow resistance against the air flow in the intake air passage is eliminated, and fuel gas is allowed to spout out from the injection holes provided in the wall surrounding the passage in a gas injection nozzle to be mixed with the air flowing through the passage, the passage being formed so that its cross section is the same as that of the air passage of the intake air pipe.

By this, an increase in flow resistance due to equipping a fuel gas injection nozzle, which causes the pressure loss of the intake air flow, is prevented, the reduction in engine output due to the reduction in positive pumping loss, etc. is eliminated, and required engine output is maintained.

As fuel gas is injected simultaneously from multiple holes provided in the wall surrounding the inner room through which the intake air flows, the mixing of the fuel gas and air is done evenly and a mixture of uniform fuel/air ratio can be supplied into the combustion chamber.

Therefore, poor combustion or occurrence of knocking due to the nonuniformity of fuel/air ratio in the combustion chamber of an engine is prevented.

Further, according to the present invention, fuel gas can be injected by single gas injection nozzle section so that the mixture of uniform fuel/air ratio is supplied to the combustion chamber of an engine in which a plurality of intake air passage are formed in the cylinder head to introduce the air into the combustion chamber. Therefore, an improvement in combustion efficiency and the prevention of occurrence of abnormal combustion such as knocking are possible.

1. A gas injection device of gas engine which is constituted so that fuel gas is supplied through a gas supply pipe to a gas injection nozzle section located in an intake air passage, the fuel gas is spouted into the air flowing through the gas injection nozzle section to be mixed with the air and supplied into the combustion chamber, wherein
said injection nozzle section comprises an inner room of which the surrounding wall is provided with single or a plurality of injection holes and of which the upstream side opening and downstream side opening are communicated with said intake air passage, and an outer gas chamber formed between the inner wall surrounding said inner room and the outer wall surrounding said inner wall, the fuel gas being introduced to said outer gas chamber, and
the fuel gas introduced in the outer gas chamber via an adjusting valve for adjusting supply amount of the fuel gas is spouted into the inner room from the hole or holes provided in the inner wall.

2. A gas injection device according to claim 1, wherein said inner room is formed so that the cross section perpendicular to the center line of said intake air passage is of polygonal shape.

3. A gas injection device according to claim 1, wherein each opening area of each of said injection holes is larger with increasing distance from the part at which said gas supply pipe is connected to said outer gas chamber.

4. A gas injection device according to claim 1, wherein the opening area of adjacent injection hole is different from each other in the direction of the air flow in a way in which the opening area of each of said injection holes is larger in upstream side.

5. A gas injection device according to claim 1, wherein all of said injection holes have the same opening area.

6. A gas injection device according to claim 1 or 2, wherein said injection holes are slit-like holes extending in the direction along the sides of said polygon and the width of each of the holes is larger with increasing distance from the part at which said gas supply pipe is connected to said outer gas chamber.

7. A gas injection device according to claim 1 or 2, wherein said injection holes are provided in two side walls of said inner room parallel to the center line of the opening in the outer wall to which said gas supply pipe is connected.

8. A gas injection device according to claim 1, wherein said inner room is partitioned with partition wall or walls into a plurality of sections corresponding to the number of intake air passages in the cylinder head to guide the air into the combustion chamber, and each section is communicated with each of said intake air passages in the cylinder head.

9. A gas injection device according to claim 8, wherein single injection hole is provided in each side wall of each section, each of the side walls facing the outer gas chamber.

10. A gas injection device according to claim 1, wherein said outer gas chamber is provided with a plurality of gas entrance openings to which gas supply pipes are connected.

11. A gas injection device according to claim 10, wherein an upstream header having a certain internal volume is provided on said gas supply pipe line, and the upstream header is connected to said outer gas chamber with a plurality of gas supply branch pipes.

12. A gas injection device according to claim 11, wherein a adjusting valve for adjusting the supply amount of gas fuel is provided on the gas supply pipe line upstream said upstream side header.

13. A gas injection device according to claim 11, wherein a adjusting valve for adjusting the supply amount of gas fuel is provided on each of the gas supply branch pipe lines.

14. A gas injection device according to claim 1, wherein said gas injection nozzle section is provided in each of the intake air branch pipes which branch off from a main intake air pipe to be connected to each cylinder of an engine.
